(19) United States
(12) Patent Application Publication
(10) Pub. No.: US 2007/0206911 A1
(43) Pub. Date: Sep. 6, 2007

(54) Gold Metal Cylinder Fiber

(75) Inventors: Philipp Kornreich, North Syracuse, NY (US); Douglas V. Keller, Fayetteville, NY (US); James Flattery, Syracuse, NY (US)

Correspondence Address: BOND, SCHOENECK & KING, PLLC, ONE LINCOLN CENTER, SYRACUSE, NY, 13202-1355, US

(73) Assignee: FANASYS, LLC, Syracuse, NY (US)

(21) Appl. No.: 11/530,525

(22) Filed: Sep. 11, 2006

Related U.S. Application Data
(60) Provisional application No. 60/715,537, filed on Sep. 9, 2005.

(51) Int. Cl. G02B 6/02; C03B 37/028; C03C 25/46

(52) U.S. Cl. 385/123; 65/412; 65/431

(57) ABSTRACT

An optical fiber having a thin layer of gold positioned between the core and cladding. The gold layer is vacuum deposited on a rotating clean glass rod which will become the fiber core. The rod is inserted into a tube that will form the cladding of the fiber. The tube is sealed and placed in a hot tin bath inside a stainless steel pressure chamber that is pressurized and heated to collapse the cladding around the gold-coated core, thereby forming a fiber perform that may be pulled to form the gold metal cylinder fiber of the present invention. The fiber may be cleaved at one end and etched to expose a gold cylinder, thereby forming a highly responsive sensor.

### CROSS-REFERENCE TO RELATED APPLICATIONS

This application claims priority to U.S. Provisional Patent Application Ser. No. 60/715,537, filed Sep. 9, 2005.

### BACKGROUND OF THE INVENTION

1. Field of the Invention

The present invention relates to optical fibers and, more specifically, to an optical fiber having improved characteristics.

2. Description of the Related Art

An optical fiber is a cylindrical dielectric waveguide, usually made of glass, that transmits light along its axis by the process of total internal reflection. The fiber generally consists of a denser core surrounded by a cladding layer and is made by constructing a large-diameter preform that is pulled to form a long, thin optical fiber. Although optical fibers are used primarily for the transmission of communications, optical fibers have been used as sensors to measure strain, temperature, pressure and other parameters. The light absorption spectra and light intensity dependence of conventional optical fibers, however, limit their utility for such applications.

### BRIEF SUMMARY OF THE INVENTION

It is therefore a principal object and advantage of the present invention to provide an optical fiber having an improved light absorption spectrum.

It is an additional object and advantage of the present invention to provide an optical fiber having improved light intensity dependence.

It is a further object and advantage of the present invention to provide an optical fiber that may be used as a sensor.

It is another object and advantage of the present invention to provide an process for manufacturing improved optical fibers.

In accordance with the foregoing objects and advantages, the present invention comprises an optical fiber having a thin layer of gold positioned between the core and cladding. The gold layer is vacuum deposited on a rotating clean glass rod which will become the fiber core. The rod is inserted into a tube that will form the cladding of the fiber. The tube is sealed and placed in a hot tin bath inside a stainless steel pressure chamber that is pressurized and heated to collapse the cladding around the gold-coated core, thereby forming a fiber perform that may be pulled to form the gold metal cylinder fiber of the present invention. The fiber may be cleaved at one end and etched to expose a gold cylinder, thereby forming a highly responsive sensor having various uses.

### BRIEF DESCRIPTION OF THE DRAWINGS

The present invention will be more fully understood and appreciated by reading the following Detailed Description in conjunction with the accompanying drawings, in which:

FIG. 1 is a perspective view of a gold metal fiber according to the present invention.

FIG. 2 is schematic of a hot tin bath according to the present invention.

FIG. 3 is a perspective view of a pressure vessel according to the present invention.

FIG. 4 is a schematic of an ampoule according to the present invention.

FIG. 5 is a schematic of a fiber drawing tower according to the present invention.

FIG. 6 is a perspective view of a first embodiment of a gold metal fiber sensor according to the present invention.

FIG. 7 is a perspective view of a second embodiment of a gold metal fiber sensor according to the present invention.

FIG. 8 is a schematic of a sensing process according to the present invention.

FIG. 9 is a schematic of a gold metal fiber sensor system according to the present invention.

### DETAILED DESCRIPTION OF THE INVENTION

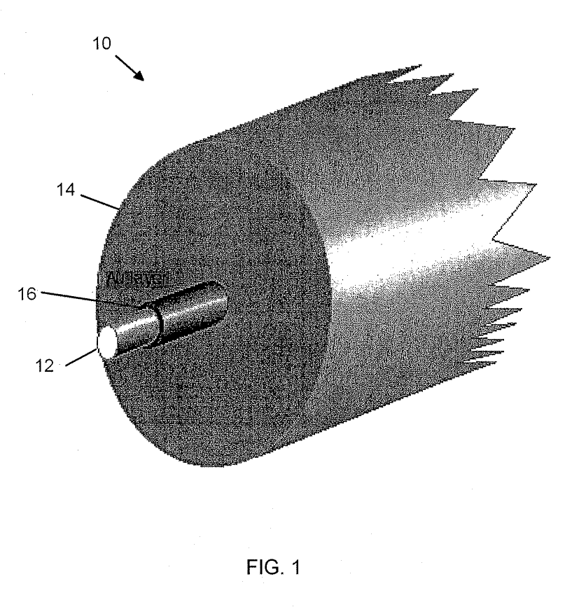

Referring now to the drawings, wherein like reference numerals refer to like parts throughout, there is seen in FIG. 1 an optical fiber 10 according to the present invention. Fiber 10 comprises a glass core 12, a glass cladding 14, and a layer of gold 16 disposed between core 12 and cladding 14.

Fabrication of fiber 10 starts with the vacuum deposition of a gold film 18 on a rotating 0.5 mm diameter glass rod 20. Before deposition, glass rod 20 is thoroughly cleaned. Glass rod 20 rotates during the deposition process so that a uniform gold metal film 18 is deposited thereon. Glass rod 20 eventually becomes core 12 of fiber 10. The same gold metal film 18 may be deposited on flat glass pieces so that it may be measured. The thickness of the gold metal film 18 on rod 20 is equal to 1/π times the thickness of the deposited film on flat glass pieces. Thus, it is possible to determine the thickness of the deposited gold metal film 18 on core rod 20.

Coated glass rod 20 is removed from the vacuum system and inserted into a glass tube 22 having a 1.5 mm inside diameter and a 6.3 mm outside diameter that has been sealed at one end. Tube 22 will eventually form cladding 14 of fiber 10. The gold will not be affected by transporting it through the air between the vacuum system and cladding tube 22. Before core rod 20 is placed into cladding tube 22, cladding tube 22 is thoroughly cleaned.

A Corning type 7056 glass with a softening point of 702° C. and an index of refraction of 1.487 may be used for core rod 20 and a Corning type 7052 glass with a softening point of 712° C. and an index of refraction of 1.484 for the cladding tube 22. Alternatively, Corning type 7440 (“Pyrex”) glass with a softening point of 821° C. and an index of refraction of 1.474 may be used for both the core rod 20 and cladding 22. In the later case, gold film 18 would have to provide some guiding.

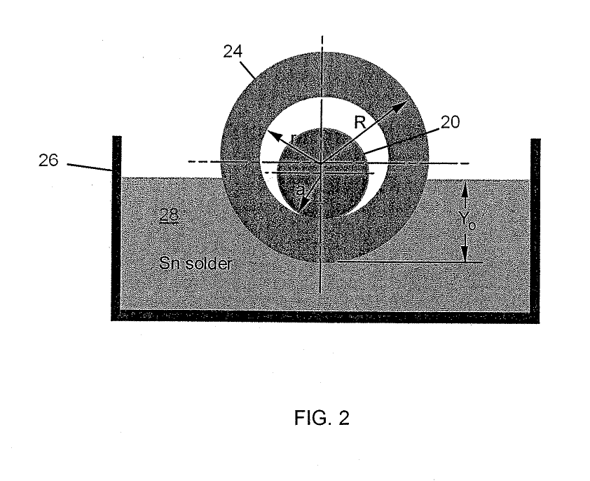

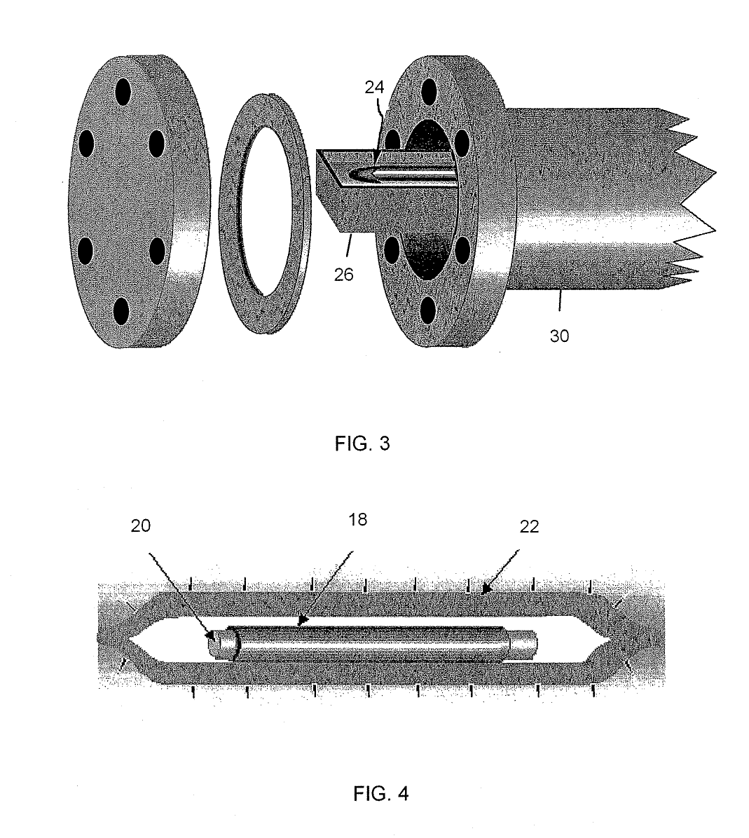

After placing coated core rod 20 into cladding tube 22, cladding tube 22 is evacuated and sealed to form an ampoule 24. Ampoule 24 is placed into a boat 26 filled with tin (Sn) solder 28, as seen in FIG. 2. Boat 26 is placed into a stainless steel pressure chamber 30 is then closed and pressurized to about 27 atmospheres (about 400 lbs per square inch) before preheating in a preheat furnace (not shown) to a temperature of 300 degrees Celsius to melt Sn solder 28, as seen in FIG. 3. Ampoule 24 floats in the liquid Sn solder 28, heating it uniformly along its length.

Stainless steel pressure chamber 30 is then moved into a second furnace (not shown) set to a temperature of 630 degrees Celsius (for the lower temperature type 7052 or 7056 glass). When ampoule 24 reaches a temperature of 620 degrees Celsius, cladding tube 22 collapses onto the core rod 20, trapping the thin gold film 18 between them, as seen in FIG. 4. Collapsed ampoule 24 should have a diameter of 6.139 mm. Note that the collapsing occurs at a temperature well below the softening temperature of the glass. While the collapsing process is not visible while ampoule 24 is in pressure chamber 30, theory suggests that the collapsing process occurs very rapidly once the glass has reached the proper temperature because, at that temperature, the glass has the proper viscosity for collapse.

The collapsing of ampoule 24 forms a fiber perform 36. Pressure chamber 30 containing perform 36 is slowly returned to preheat furnace 32. This movement should take 4 to 6 hours, thereby annealing perform 36 in the process. The glass cools while floating in the liquid Sn. This assures that perform 36 remains straight while the glass hardens.

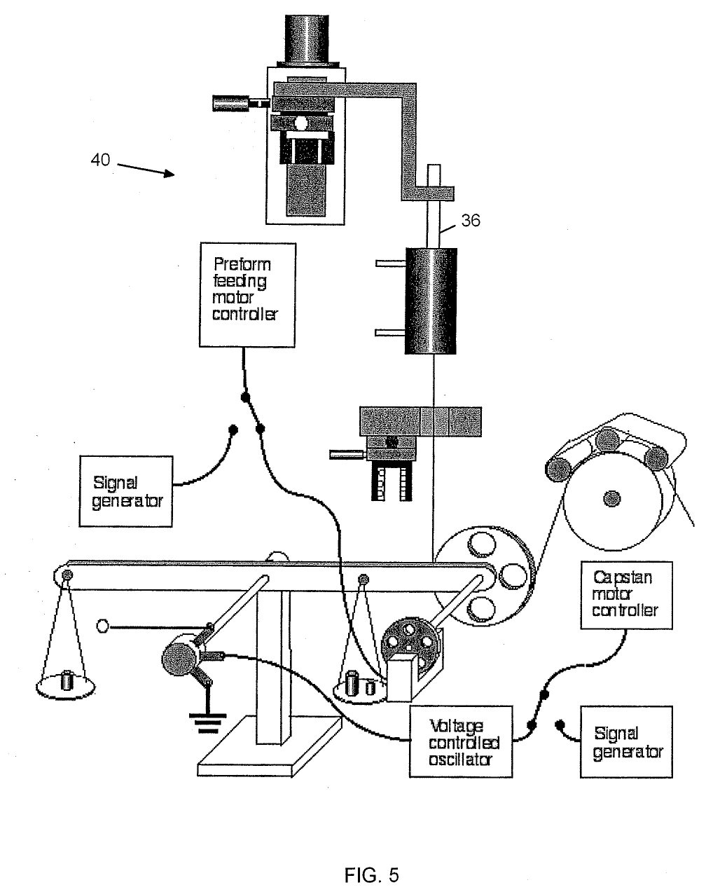

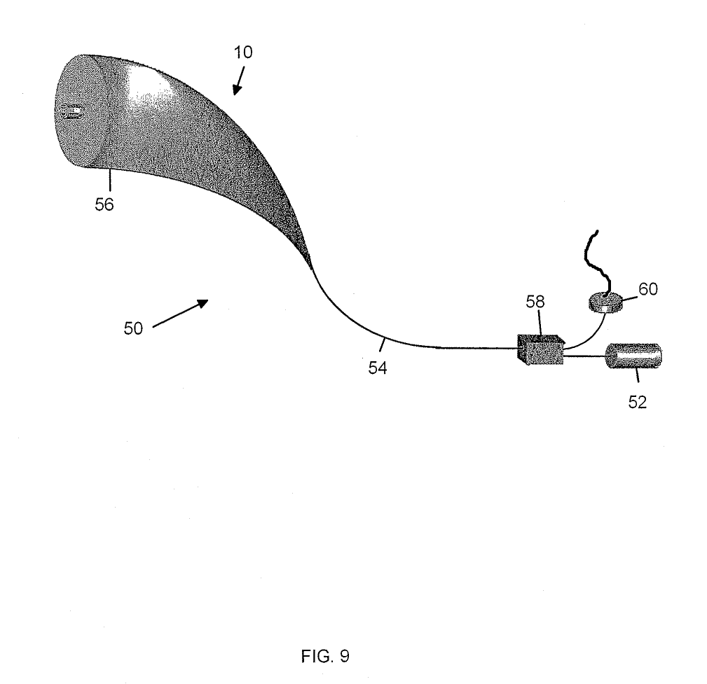

Preform 36 is preferably about 20 cm long at this point. Next, glass handles (not shown) that are each about 30 cm long are attached to each end of perform 36. Preform 36 is mounted in a fiber drawing tower 40, as seen in FIG. 9. Fiber 10 is then drawn from perform 36 in a fiber pulling tower, as seen in FIG. 5. A force of 200 grams is applied to fiber 10 during the pulling process. Fiber 10 is pulled at a temperature of 630 degrees Celsius for the type 7052 or 7056 glass with the lower softening point. At this temperature, the glass has a higher viscosity than the gold. Thus, the gold is extruded from a thickness of 0.1 μm in preform 36 to a thickness of 2.06 nm in fiber 10 by the surrounding glass. If the viscosity of the glass is less than the viscosity of the gold, the gold will tear during the fiber pulling process. The 0.5 mm diameter core of the preform is drawn to a 10.03 μm core in fiber 10 and the 6.139 mm outside diameter of preform 36 becomes the 126.4 μm outside diameter of fiber 10.

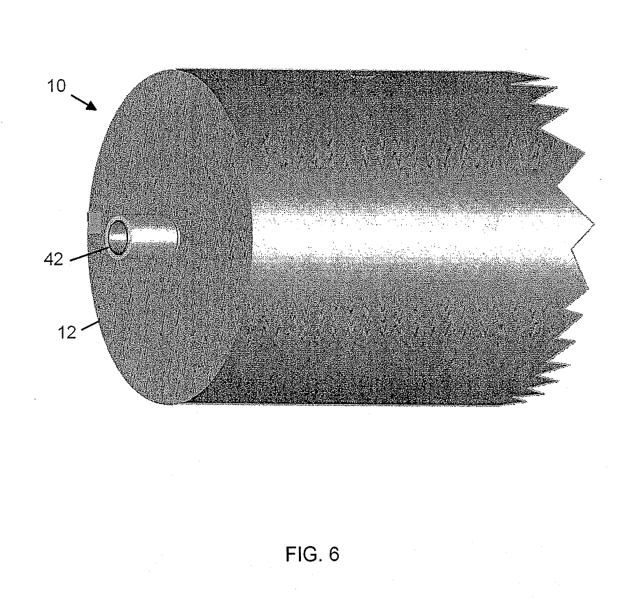

Fiber 10 according to the present invention may be used as a sensor. Since one can etch glass without etching the gold metal layer positioned between core 12 and cladding 14, it is possible to construct a fiber 10 with a protruding very thin hollow gold cylinder 42, as seen in FIG. 6. These devices are made by first fabricating fiber 10 with a gold layer between core 12 and cladding 14, as explained above. An end of fiber 10 is then cleaved to obtain a flat uniform surface. Next, the cleaved end of fiber 10 is submerged in hydrofluoric acid. The acid will etch away some of the glass, leaving a protruding hollow gold cylinder 42.

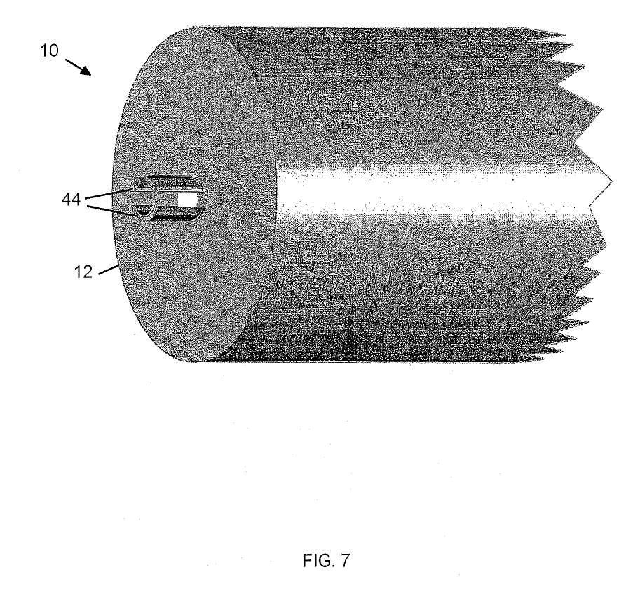

An alternate arrangement is to fabricate a fiber 10 with two or more thin gold cylindrical arc sections 44 at the core cladding boundary. One end of fiber 10 is then cleaved to obtain a flat uniform surface. Next, the cleaved end of fiber 10 is submerged in hydrofluoric acid. The acid will etch away some of the glass leaving protruding gold cylindrical arc sections 44, as seen in FIG. 7.

The protruding gold cylinder 42 or cylindrical arc sections 44 of fiber 10 may be used as strain or fluid flow sensors. Since the very thin sections are easily deflected these can be very sensitive detectors. These devices can be also used as pressure sensors. They will sense any pressure induced strain in a material in which they are imbedded.

The lowest order modes propagate through gold layer 16 and the glass immediately next to gold layer 16. Thus, any light reflected from the end with the protruding gold structures 42 or 44 will be very sensitive. Nanometer scale structures, such as molecules, can be loaded onto the protruding gold sections 42 or 44 of the fiber. A light beam can be sent through fiber 10. Some of the light will be reflected from the fiber end containing the gold structures 42 or 44. Since light propagates through gold film 16 it will carry back information about the material placed on gold structures 42 or 44.

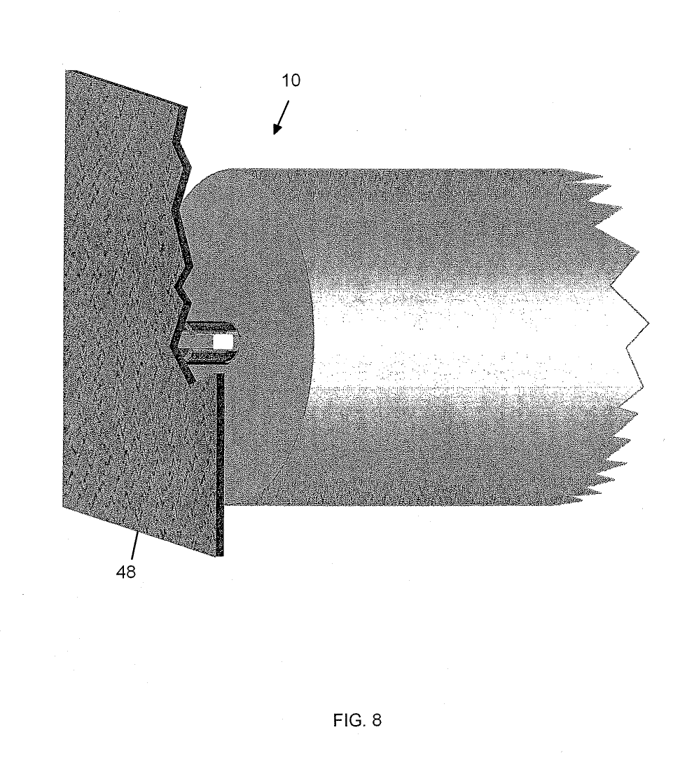

The molecules and the protruding gold structures 42 and 44 can also be subjected to electrical, magnetic or stress fields and the change do to these effects can be analyzed by the reflected light. The sample molecules can be loaded onto fiber 10 by coating a glass slide 48 with a thin film of suspension containing the molecules to be tested. The protruding gold structures 42 or 44 of fiber 10 are dipped carefully into the suspension film on glass slide 48, as seen in FIG. 8. Before measuring, fiber 10 is pulled away from the glass slide, thereby depositing a small amount of the suspension with the molecules on the gold structures 42 or 44 protruding from the fiber.

A sensor system 50 using a gold metal fiber 10 according to the present invention is seen in FIG. 9. Light from a laser 52 propagates along fiber 54 to a sensor 56 (i.e., fiber 10 having extending cylindrical gold cylinder or cylindrical sections) through a directional coupler 58. The reflected light from sensor 56 is directed by directional coupler 58 to a detector 60. If the distance between directional coupler 58 and sensor 56 is long, a standard single mode fiber may be used between a short piece of fiber 10 and directional coupler 58.

What is claimed is:

1. An optical fiber, comprising:
a core;
a cladding surrounding said core; and
a layer of gold positioned between said core and said cladding.

2. The fiber of claim 1, wherein said layer of gold is about 2.06 nanometers thick.

3. The fiber of claim 2, wherein said core has a diameter of about 10.03 micrometers.

4. The fiber of claim 3, wherein said cladding has an outside diameter of 126.4 micrometers.

5. The fiber of claim 1, wherein said core comprises glass having a softening point of about 702 degrees Celsuis and an index of refraction of about 1.487.

6. The fiber of claim 2, wherein said cladding comprising glass having a softening point of about 712 degrees Celsuis and an index of refraction of about 1.484.

7. The fiber of claim 1, wherein said core and said cladding comprise glass having a softening point of about 821 degrees Celsuis and an index of refraction of about 1.474.

8. A method of forming an optical fiber, comprising the steps of:
depositing a gold film on a glass rod;
inserting said glass rod coated with said gold film into a glass tube;
floating said glass tube containing said glass rod coated with said gold film in a liquid bath;
enclosing said floating said glass tube in a pressure chamber;
heating said pressure chamber until said glass tube collapses around said glass rod coated with said gold film to form a fiber perform; and
pulling an optical fiber from said fiber perform.

9. The method of claim 8, wherein said gold film is deposited on said glass rod by vacuum deposition.

10. The method of claim 9, wherein said liquid bath comprises preheated tin solder.

11. The method of claim 10, wherein the step of heating said pressure chamber until said glass tube collapses around said glass rod coated with said gold film to form a fiber perform comprises the steps of:
placing said pressure chamber in a preheated furnace;
pressurizing said pressure chamber;
heating said pressure chamber; and
cooling said pressure chamber.

12. The method of claim 11, wherein said preheated furnace is preheated to a temperature of about 300 degrees Celsius.

13. The method of claim 11, wherein said pressure chamber is pressurized to about 27 atmospheres.

14. The method of claim 11, wherein said step of heating said pressure chamber comprises placing said pressure chamber in a furnace at a temperature of about 630 degrees Celsius until said pressure chamber reaches about 620 degrees Celsius.

15. The method of claim 11, wherein said pressure chamber is heated in a different furnace than said preheated furnace.

16. The method of claim 15, wherein the said step of cooling said pressure chamber comprises the steps of slowly moving said pressure chamber back to said preheated furnace.

17. An optical fiber sensor, comprising:
a core;
a cladding surrounding said core; and
a layer of gold positioned between said core and said cladding, wherein a portion of said layer of gold extends beyond said core and said cladding.

18. The sensor of claim 17, wherein said portion of said layer of gold extends beyond said core and said cladding comprises a cylinder.

19. The sensor of claim 17, wherein said portion of said layer of gold extends beyond said core and said cladding comprises two arcuate cylindrical sections.

20. The sensor of claim 17, further comprises a glass slide containing a target substance in contact with said portion of said layer of gold extends beyond said core and said cladding.
